(19) United States
(12) Patent Application Publication
(10) Pub. No.: US 2015/0130629 A1
(43) Pub. Date: May 14, 2015

(54) DETERMINING UTILIZATION OF ELECTRONIC ASSETS

(71) Applicant: QUALCOMM Incorporated, San Diego, CA (US)

(72) Inventors: An Mei Chen, San Diego, CA (US); Robert Morris Morandy, San Diego, CA (US); Vijaya Datta Mayyuri, San Diego, CA (US); Jangwon Lee, San Diego, CA (US); Paul David Milne, Oceanside, CA (US)

(73) Assignee: QUALCOMM Incorporated, San Diego, CA (US)

(21) Appl. No.: 14/290,694

(22) Filed: May 29, 2014

Related U.S. Application Data
(60) Provisional application No. 61/902,746, filed on Nov. 11, 2013.

(51) Int. Cl. H04Q 9/00

(52) U.S. Cl. CPC H04Q 9/00
USPC 340/870.02

(57) ABSTRACT

An asset tag for monitoring usage of an electronic asset includes a usage monitor configured to monitor usage of the electronic asset and a transmitter configured to transmit an indication of the usage of the electronic asset. The asset tag may include a socket configured to receive a first plug, wherein the first plug comprises a plug of the electronic asset; a second plug electrically coupled to the socket, wherein the second plug is configured to transmit current to the socket; and, a power source configured to power the usage detector.

This application claims the benefit of U.S. Provisional Application 61/902,746 filed 11 Nov. 2013, the entire content of which is incorporated by reference.

### TECHNICAL FIELD

This disclosure relates to electronic asset management.

### BACKGROUND

Large organizations, such as corporations, governments, and universities, often invest large amounts of money into electronic assets and other types of physical assets. Common examples of such physical assets may include computer equipment, audio/video equipment, IT infrastructure equipment, furniture, and other types of office equipment. Many organizations may also own or manage various types of industry-specific assets. For example, a semiconductor manufacturer may own test benches for testing chips, and a police force may own a fleet of bicycles. For a law firm or accounting firm, certain documents or papers may be considered assets. Generally speaking, any physical object may be considered by an organization to be an asset, and what constitutes an asset may vary from organization to organization.

As organizations get larger, it is not uncommon for them to occupy multiple floors of a building, multiple buildings, or even multiple sites, often making keeping track of all of the organization's assets quite challenging. As technology makes many assets smaller and more portable, managing such assets becomes even more challenging. In order to keep track of all of their assets, many organizations implement asset management programs that require assets to be associated with a particular location, a particular individual, or a particular group. Such systems, however, typically lose track of an undesirably large percentage of assets because assets get moved to new locations or transferred to new individuals without the system being updated. Many organizations also utilize asset management equipment to further keep track of all of their assets. Such equipment typically utilizes barcode or radio frequency identification (RFID) technology to determine the location of certain assets.

### SUMMARY

This disclosure introduces techniques for determining utilization, and in some examples utilization and location, of electronic assets by, for example, monitoring a usage of an electronic asset and transmitting an indication of the usage of the electronic asset.

In one example, a method for determining utilization of electronic assets includes monitoring a usage of an electronic asset and transmitting an indication of the usage of the electronic asset.

In another example, an asset tag for monitoring usage of an electronic asset includes a usage monitor configured to monitor usage of the electronic asset and a transmitter configured to transmit an indication of the usage of the electronic asset.

In another example, an apparatus for determining utilization of electronic assets includes means for monitoring a usage of an electronic asset and means for transmitting an indication of the usage of the electronic asset.

In another example, a computer-readable medium storing instructions that when executed cause one or more processors to monitor a usage of an electronic asset and transmit an indication of the usage of the electronic asset.

The details of one or more examples are set forth in the accompanying drawings and the description below. Other features, objects, and advantages will be apparent from the description and drawings, and from the claims.

### BRIEF DESCRIPTION OF THE DRAWINGS

FIG. 1A shows an example asset tracking system that may be used in accordance with the techniques of this disclosure.

FIG. 1B shows an example of an asset tag that may be used as part of an asset tracking system in accordance with the techniques of this disclosure.

FIG. 1C shows an example of a receiver that may be used as part of an asset tracking system in accordance with the techniques of this disclosure.

FIG. 1D shows an example of an asset tag that may be used as part of an asset tracking system in accordance with the techniques of this disclosure.

FIG. 2 shows an example asset tracking system that may be used in accordance with the techniques of this disclosure.

FIG. 3 shows an example of an asset tag that may be used as part of an asset tracking system in accordance with the techniques of this disclosure.

FIG. 4 shows an example of a process that may be performed by either an individual asset tag or by an asset tracking system in accordance with the techniques of this disclosure.

FIG. 5 shows an example of a process that may be performed by either an individual asset tag or by an asset tracking system in accordance with the techniques of this disclosure.

FIG. 6 shows a flowchart shows an example process for monitoring usage of an electronic asset.

### DETAILED DESCRIPTION

In some use cases, it may not only be important to be able to know the location of an electronic asset, but also to determine whether the electronic asset is being actively utilized. Such usage information may be particularly valuable for high end electronic equipment which can sometimes cost hundreds of thousands of dollars. Knowing whether an electronic asset is being used or not being used may allow for more effective ways of allocating resources and reducing the need for additional purchases. Accordingly, this disclosure introduces techniques for determining utilization of electronic assets by, for example, monitoring a usage of an electronic asset and transmitting an indication of the usage of the electronic asset. The techniques of this disclosure, which generally relate to determining usage of an electronic asset, may be integrated into a typical asset location system. Accordingly, a system in accordance with the techniques of this disclosure may determine both location and usage for an electronic asset as opposed to just location.

According to the techniques of this disclosure, an asset tag can be affixed to an asset to determine usage of the asset as opposed to just location. The asset tag may then transmit to a central processing device, such as a server, information indicating a usage time or a number of usages for the asset. Alternatively or additionally, the asset tag may transmit an idle time (or active time) for the asset. As will be explained in greater detail below, in some examples, the asset tag may transmit the information via an intermediary device such as a receiver. The asset tag may, for example, determine usage of the asset by monitoring one or more of an on/off state of the asset, a temperature of the asset, a current draw of the asset, and/or movement (for example, via measuring an acceleration using an accelerometer) of the asset. It should be understood that these are just examples, and other characteristics may also be monitored to determine usage.

The asset tag may take several forms and may affix to, or be integrated into, the device in several different manners. In some instances the asset tag may be a small device (e.g. the size of a couple of quarters stacked on top of one another) that affixes externally to an asset. This type of asset tag may, for example, be an after-market asset tag, meaning the asset tag was not manufactured specifically for the electronic asset to which it is attached but instead was affixed at a later time. If the after-market asset tag is configured to detect a temperature of the asset, then it may be affixed to a portion of the asset that exhibits a temperature change during use, such as to a power supply, battery, circuit board, or processor. If the after-market the asset tag is configured to detect movement, then it may be affixed to a portion of the asset that moves during use, such as to a fan or motor.

Instead of utilizing after-market asset tags, electronic assets may come with integrated asset tags. For example, a phone or a computer may have the asset tag functionality built-in and allow for a user or system administrator to enable or disable the functionality. As another example, a piece of test equipment may include a main circuit board for performing test functionality, and the main circuit board may additionally include asset tag circuitry for performing the asset tracking techniques described in this disclosure.

In some instances, an after-market asset tag may be affixed using an adhesive, while in other instances the asset tag may connect to the asset in such a way that once connected the asset tag is subsequently integrated with the asset. One example of such an asset tag may take the form of a plug-receptacle appliance that includes both plug prongs and a plug receptacle. For example, a plug of the asset may plug into a plug receptacle of the asset tag, and a plug of the asset tag may plug into a power source, e.g., such as an AC or DC power source, such that power passes through the asset tag to the asset. Once connected, the plug-receptacle in essence replaces, or couples to, the original power plug of the asset and is configured to perform various asset tracking functionality described in this disclosure without affecting normal operation of the electronic asset. In some examples, the asset tag may be self-powered, e.g., by battery power or line power, or a combination of both. In the plug example above, the asset tag may be powered by the line power when plugged into a power source and/or powered by battery otherwise. In various examples, the asset tag may include suitable power generation or conversion circuitry, e.g., such as ac-dc conversion and/or regulation circuitry.

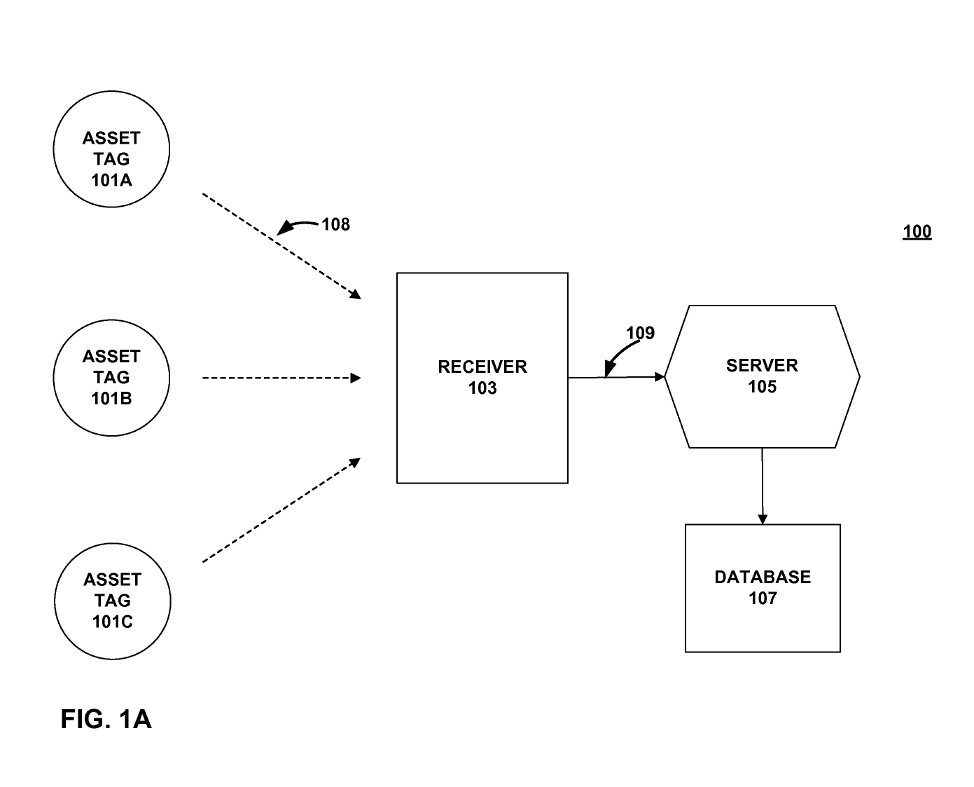

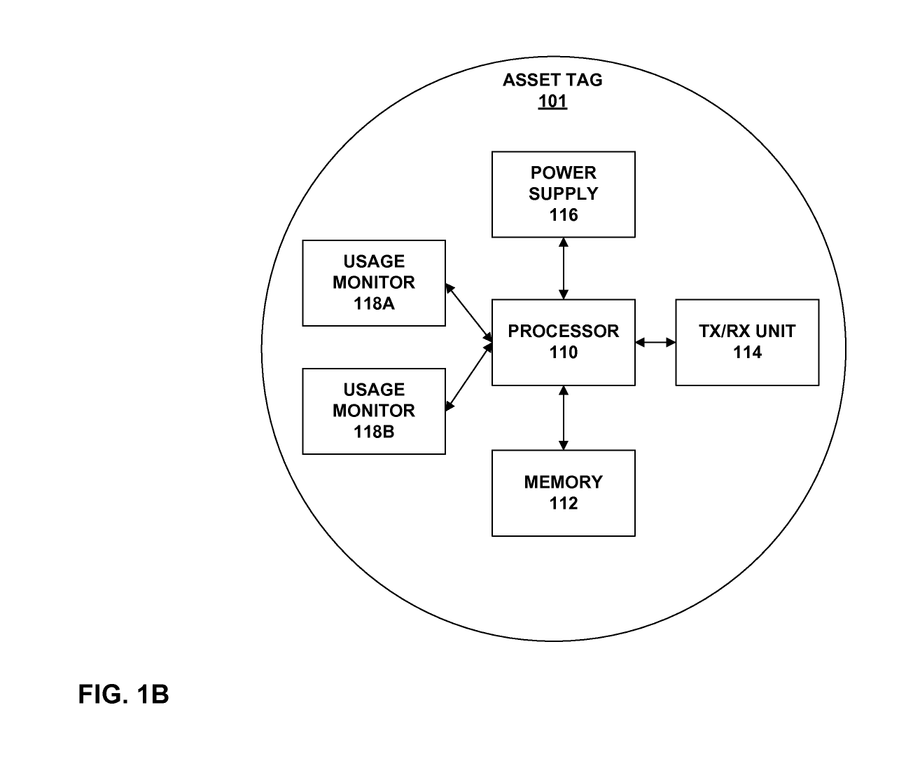

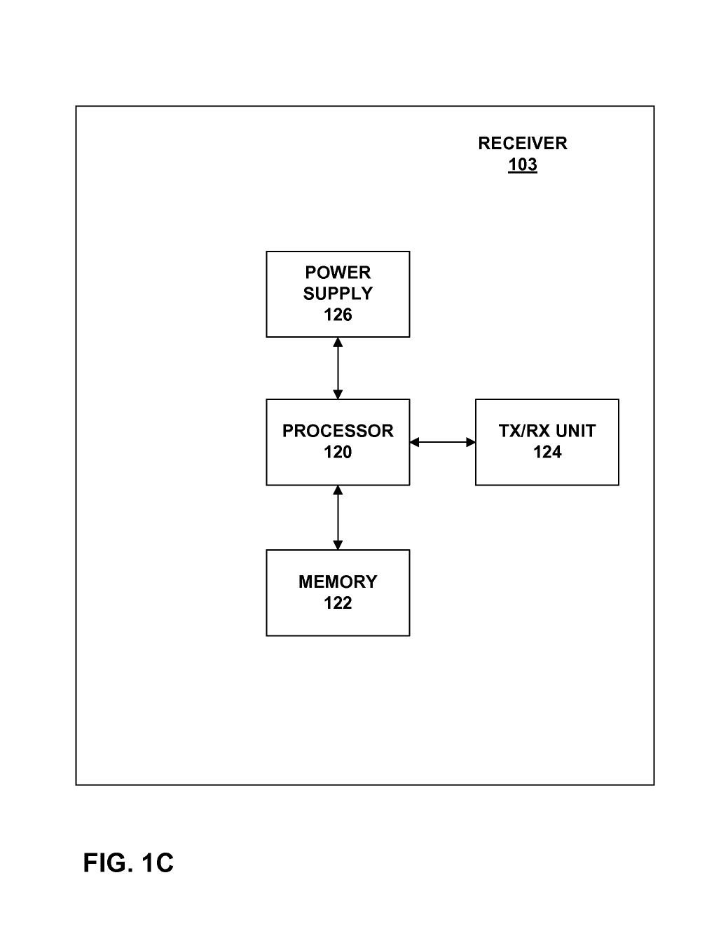

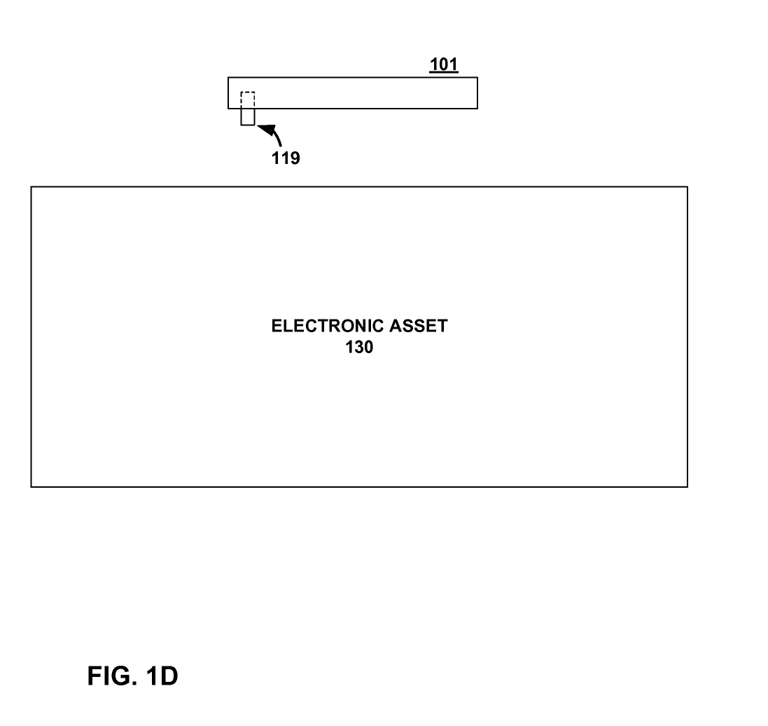

FIG. 1A shows an example asset tracking system 100 that may determine utilization of electronic assets by, for example, monitoring a usage of an electronic asset and transmitting an indication of the usage of the electronic asset. Asset tracking system 100 may also perform location tracking for electronic assets. As will be explained in greater detail below, usage of an electronic asset may be determined, for example, based on monitoring power states of electronic assets, monitoring current being drawn by an electronic asset, monitoring temperature variations in an electronic asset, monitoring movement of an electronic asset, and/or by monitoring other characteristics of the electronic asset. System 100 includes asset tags 101A-101C, receiver 103, server 105, and database 107. Asset tags 101A-101C may be configured to detect usage in accordance with the techniques of this disclosure. Asset tags 101A-101C are intended to be generalized representations of asset tags and may take any form or perform any functionality described in this disclosure.

It is contemplated that system 100 may be implemented using a variety of different types of asset tags. For example, asset tag 101A may detect usage of an electronic asset using a first technique of this disclosure. Asset tag 101B may detect usage of an electronic asset using a second, different technique of this disclosure, and asset tag 101C may detect usage of an electronic asset using a third, different techniques. In some implementations, asset tags 101A-101C may each perform multiple techniques described in this disclosure.

Asset tags 101A through 101C are configured to be attached to various assets, and each of asset tags 101A through 101C may be associated with a unique asset tag ID. Each of asset tags 101A and 101C may be configured to transmit a signal that can be detected by various receivers, such as receiver 103. FIG. 1, for example, shows asset tag 101A transmitting information to receiver 103 over communication channel 108. Asset tags 101B and 101C may communicate with receiver 103 in a similar manner to that of asset tag 101A. Receiver 103 can then transmit to server 105, over communication channel 109, information that includes the unique asset tag IDs detected by receiver 103. As will be explained in greater detail below, in addition to the unique asset tag ID, receiver 103 may transmit additional information for the asset tag ID, such as usage information, to server 105. The association of receiver 103 with a unique asset tag ID may then be stored by server 105 in database 107. The usage information associated with a particular asset tag ID may also be stored in database 107.

Asset tags 101A-101C may either engage in 1-way communication or 2-way communication with receiver 103. An asset tag configured only for 1-way communication may send information to receiver 103 but not receive information from receiver 103. Limiting the asset tag to 1-way communication may simplify the hardware requirements and possibly make the asset tags smaller and less expensive to manufacture. Limiting the asset tag to 1-way communication may additionally reduce battery consumption. In some implementations, asset tags may engage in 2-way communication, such that the asset tag may both send information to and receive information from receiver 103. In a system with asset tags configured for 2-way communication, server 105 may initiate a real-time inquiry of the asset usage detected by the asset tags.

Database 107 may also store a location for receiver 103. Thus, based on the location of receiver 103, server 105 can provide to a user of asset tracking system 100 an estimate of the location for an asset tag. For example, if receiver 103 detects a signal transmitted by asset tag 101A, then it can be determined that asset tag 101A is in a room, building, or other location associated with receiver 103. Although not shown in FIG. 1 for simplicity, asset tracking system 100 may include multiple receivers dispersed across an area for which assets are to be monitored. As introduced previously, in addition to storing a location for asset tags 101A-101C, database 107 may also store usage information associated with each asset tag.

Server 105 and database 107 are generally intended to represent any computing system and data storage system and may take many different forms. Server 105 and database 107, collectively, may, for example, comprise an application server, a catalog server, a database server, a file server, a home server, a mobile server, a proxy server, a stand-alone server, a web server, a personal computer, a mobile device such as a smartphone or tablet, or any other type of network device. In some examples, some or all of the functionality described herein relative to server 105 and database 107 may be performed by receiver 103.

Communication channel 108 generally represents any suitable communication medium, or collection of different communication media, for transmitting data between asset tag 101A and receiver 103. Communication channel 108 is usually a relatively short-range communication channel, and may implement a physical channel structure similar to Wi-Fi, Bluetooth, 3G, 4G, cellular, or the like, such as implementing defined 2.4, GHz, 3.6 GHz, 5 GHz, 60 GHz or Ultrawideband (UWB) frequency band structures. However, communication channel 108 is not necessarily limited in this respect, and may comprise any wireless or wired communication medium, such as a radio frequency (RF) spectrum or one or more physical transmission lines, one or more proprietary communication protocols, or any combination of wireless and wired transmission media.

Communication channel 109 generally represents any suitable communication medium, or collection of different communication media, for transmitting data between receiver 103 and server 105. Communication channel 109 may be any type of short-range or long-range communication channel, and may comprise any wireless or wired communication medium, such as a radio frequency (RF) spectrum or one or more physical transmission lines, or any combination of wireless and wired media. In other examples, communication channel 109 may form part of a packet-based network, such as a wired or wireless local area network, a wide-area network, or a global network such as the Internet. Additionally, communication channel 109 may be used by receiver 103 and server 105 to create a peer-to-peer link.

As introduced above, asset tags 101A-101D may be affixed to electronic assets, monitor a usage of the electronic asset, and transmit indication of the usage of the electronic asset. Asset tags 101A-101D may, for example, monitor the usage of an electronic asset by monitoring a power state of the electronic asset. The power state may, for example, correspond to an “on” state or an “off” state or may, for example, correspond to a “low” state, “medium” state, or “high” state for electronic assets that may have a plurality of different “on” states. Asset tags 101A-101D may monitor the power state by recording how many times the electronic asset is turned on or off or by monitoring the amount of time an electronic asset spends in an on state and the amount of time an electronic asset spends in an off state. For some electronic devices, the on/off state may be a good indicator of usage for the electronic asset.

For some electronic assets, the on/off state may not necessarily be a good indicator of the usage of the electronic asset because the electronic asset may have periods of time where it is powered on but not being used. For such electronic assets, asset tags 101A-101D may monitor usage of the electronic asset by tracking a temperature of the electronic asset. Asset tags 101A-101D may, for example, be placed in proximity to, or integrated into, a part of the electronic asset, such as a processor or circuit board, that generates heat when being used. More specifically, asset tags 101A-101D may be positioned in proximity to, or integrated into, a part of the electronic asset that generates more, or possibly less, heat when powered on and not being used than when powered on and being used. As will be explained in greater detail below, asset tags 101A-101D may be programmed with comparison logic and threshold values that can compare a measured temperature with a threshold temperature. If the measured temperature exceeds, or in some applications falls below, the threshold temperature, the asset tag 101A may determine that the asset is active (i.e. being used). Additionally or alternatively, if the temperature falls below or exceeds the threshold temperature, asset tag 101A-101D may determine that the asset is idle or not being used. The threshold temperature may, for example, be chosen to be a temperature where the electronic asset is not only powered on but is also being used.

For some electronic assets where on/off state may not necessarily be a good indicator of the usage of the electronic asset tags 101A-101C may monitor usage of the electronic asset by tracking movement of the electronic asset. Asset tag 101A-101C may, for example, track movement of the electronic asset by an accelerometer that is included in the asset tag. Asset tags 101A-101C may, for example, be placed in proximity to, or integrated into, a part of the electronic asset, such as a fan or motor, that moves when being used. More specifically, asset tags 101A-101C may be positioned in proximity to, or integrated into, a part of the electronic asset that generates more, or possibly less, movement when powered on and not being used than when powered on and being used. As will be explained in greater detail below, asset tags 101A-101C may be programmed with comparison logic and threshold values that can compare a measured movement with a threshold amount of movement. If the measured movement exceeds, or in some applications falls below, the threshold movement level, asset tag 101A-101C may determine that the asset is active. Additionally or alternatively, if the movement falls below or exceeds the threshold movement, asset tag 101A-101C may determine that the asset is idle or not being used. The threshold movement level may, for example, be chosen to be a movement level that is indicative of use.

Asset tag 101A-101C may also be configured to detect movement by means other than just an accelerometer. For example, asset tags 101A-101C may be configured to detect movement by detecting changes in location using an asset locating system, such as system 100, or by using GPS or some other type of positioning system, such as indoor positioning systems (IPSs), including Wi-Fi-based IPSs, light-based IPSs, magnetic field-based IPSs, and other types of IPSs.

For some electronic assets where on/off state may not necessarily be a good indicator of the usage of the electronic asset tags 101A-101C may monitor usage of the electronic asset by tracking current drawn by the electronic asset. Asset tag 101A-101C may, for example, track current drawn by the electronic asset by an electric current meter (e.g. and ammeter) or power meter (e.g. a wattmeter) that is included in the asset tag. Asset tags 101A-101C may, for example, electrically couple the electronic asset to a power source such that the asset tag can monitor the current being drawn the by the electronic asset. An asset tag that monitors a current draw may, for example, be used in conjunction with an asset that draws more, or possibly less, current when powered on and not being used than when powered on and being used. As will be explained in greater detail below, asset tags 101A-101C may be programmed with comparison logic and threshold current values that can compare a measured current value with a threshold current value. If the measured current exceeds, or in some applications falls below, the threshold current value, asset tag 101A-101C may determine that the asset is active. Additionally or alternatively, if the movement falls below or exceeds the threshold current, asset tag 101A-101C may determine that the asset is idle or not being used. The threshold current level may, for example, be chosen to be a current level where the electronic asset is not only powered on but is also being used.

Usage information accumulated by asset tags 101A-101C may track usage of an electronic asset using one or more of the techniques described above. Asset tags 101A-101C may then transmit that usage information to receiver 103, which may in turn, transmit the usage information to server 105 and database 107. In a typical use case, it is contemplated that a receiver, such as receiver 103 may receive usage information from multiple asset tags, such as asset tags 101A-101B. It is also contemplated that a server, such as server 105, may receive usage information from multiple receivers. Thus, one server may be able to track usage information for an entire building, entire division, entire corporation, or some other such group.

A user of asset tracking system 100 may electronically access the usage information maintained by database 107. Server 105 may, for example, implement various search functionality and business logic techniques to present the usage information of electronic assets in a user friendly manner. As examples, server 105 may be able to search for usage information for a particular asset, rank assets by an amount of idle time (or active time), and identify assets with more than threshold amounts of idle time (or active time) over a period of time.

FIG. 1B shows an example of asset tag 101, which may generally correspond to any of asset tags 101A-101C described above. Asset tag 101 includes one or more processors (processor 110), one or more memories (memory 112), a transmission and receiving (TX/RX) unit 114, also referred to as a transmitter, a power supply 116, and one or more usage monitors. Although FIG. 1B shows two usage monitors (118A and 118B), it is contemplated that asset tag 101 may include more or fewer than two usage monitors. The components of asset tag 101 may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof.

Processor 110 may implement functionality and/or execute instructions within asset tag 101. Processor 110 is generally intended to represent all processing capabilities of asset tag 101. It is contemplated that in some implementations, the processing capabilities of asset tag 101 may actually be distributed across multiple processing elements. Processor 110 on asset tag 101 may receive and execute instructions stored by memory 112 that execute the functionality of usage monitors 118A-118B and TX/RX unit 114. These instructions executed by processor 110 may cause asset tag 101 to store information, within memory 112 during program execution.

Memory 112 within asset tag 101 may store information for processing during operation of asset tag 101. Memory 112 may include temporary memory that is not for long-term storage. Such temporary memory be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art. Memory 112 may also include one or more computer-readable storage media. Such computer-readable storage media may be configured to store larger amounts of information than volatile memory and may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Memory 112 may also store program instructions for execution by processor 110 and/or data associated with usage monitors 118A and 118B. Memory 112 in asset tag 101 is generally intended to represent all the memory that may be contained in asset tag 101, including, for example, caches, RAM, and storage media.

TX/RX unit 114 may include various mixers, filters, amplifiers, modems and other components designed for signal modulation, as well as one or more antennas and other components designed for transmitting and receiving data. In some implementations, asset tag 101 may include a transmission (TX) unit instead of a TX/RX unit, meaning that asset tag 101 can transmit information but not receive information. TX/RX unit 114 may be configured to transmit and receive data over communication channel 108 described above.

In some implementations, asset tag 101 may be configured to continuously monitor for usage but only periodically transmit usage information to receiver 103. For example, asset tag may only transmit usage information once per day or transmit usage information only when a specific type of usage event is detected. An example of a specific usage event may include an idle period that lasts longer than a threshold period of time. For location tracking purposes, asset tag 101 may periodically transmit its unique asset tag ID for detection by one or more receivers. As will be explained in greater detail below, asset tag 101 may also transmit utilization information in addition to location information.

Power supply 116 generally represents any power source or combination of power sources that may be used to power asset tag 101. As it is contemplated that after-market asset tags may in some instances be relatively small devices, it is also contemplated that power supply 116 may also be relatively small for after-market asset tags. For example, it is contemplated that some implementations of asset tag 101 may operate using one or more of what are commonly referred to as “button” or “watch” batteries. In other implementations, the size of the asset tag may be of less importance, in which case other types of batteries, including larger batteries, may be used to power asset tag 101. In some implementations, asset tag 101 may include multiple power sources, such as wall power and batter power. For asset tags that are integrated into electronic assets, power supply 116 may correspond to the power supply of the electronic asset or may be separate from the power source of the electronic asset.

Usage monitors 118A-118B may be configured to detect usage of the electronic asset to which asset tag 101 is affixed. Usage monitors 118A-118B may be a combination of hardware components and software components configured to detect the usage. Various examples will be described with respect to usage monitor 118A, but it should be understood that any functionality or configuration described with respect to usage monitor 118A may also be implemented with usage monitor 118B. As introduced above, in some examples, usage monitor 118A, may include mechanisms for monitoring a power state of the electronic asset. Usage monitor 118A may monitor the power state by recording how many times the electronic asset is turned on or off or by monitoring the amount of time an electronic asset spends in an on state and the amount of time an electronic asset spends in an off state. Usage monitor 118A may, for example, determine an on/off state of the device by being integrated or coupled to the electronic asset's power supply or by detecting other characteristics (e.g. temperature, movement, location) that is indicative of being powered on. In some examples, the asset tag may be affixed to the electronic asset in a manner where a physical movement of an on/off switch of the electronic asset can be detected by usage monitor 118A.

As discussed above, for some electronic assets, the on/off state may not necessarily be a good indicator of the usage of the electronic asset because the electronic asset may have periods of time where it is powered on but not being used. For such electronic assets, usage monitor 118A may monitor usage of the electronic asset by tracking a temperature of the electronic asset. Asset tag 101 may, for example, be placed in proximity to a part of the electronic asset, such as a processor or circuit board, that generates heat when being used. Within asset tag 101, usage monitor 118A may be positioned such that a temperature sensing element of usage monitor 118A can accurately measure the temperature of the electronic asset. In order to implement this functionality, consideration may be given to what parts of asset tag 101 are conductive and what parts are insulated. Generally speaking, if usage monitor 118A includes a temperature sensing element, the temperature sensing element may be less insulated than other components of asset tag 101.

Processor 110 may implement comparison logic that compares a measured temperature by usage monitor 118A with a threshold temperature. If the measured temperature exceeds, or in some applications falls below, the threshold temperature, processors 110 may determine that the asset is active (i.e. being used). Additionally or alternatively, if the temperature measure by usage monitor 118A falls below or exceeds the threshold temperature, processor 110 may determine that the asset is idle or not being used.

In another example implementation, asset tag 101 may not perform any sort of comparison, but instead, may transmit an indication of a measured temperature to receiver 103, such that either receiver 103 or server 105 performs the comparison. A first temperature level may be indicative of the electronic asset being turned off, while a second temperature level is indicative of the electronic asset being turned on but not used, and a third temperature level may be indicative of an electronic asset being both turned on and in use. These different temperature levels may either be pre-determined based on asset type or may be empirically determined by monitoring the electronic asset over a period of time.

For some electronic assets where on/off state may not necessarily be a good indicator of the usage of the electronic asset usage monitor 118A may monitor usage of the electronic asset by tracking movement of the electronic asset. In such an implementation, usage monitor 118A may include an accelerometer. Asset tag 101 may, for example, be placed in proximity to a part of the electronic asset, such as a fan or motor, that moves when being used. Processor 110 may implement comparison logic that compares a movement measured by usage monitor 118A with a threshold amount of movement. If the measured movement exceeds, or in some applications falls below, the threshold movement level, processor 110 may determine that the asset is active. Additionally or alternatively, if the movement falls below or exceeds the threshold movement, processor 110 may determine that the asset is idle or not being used.

Usage monitor 118A may also be configured to detect movement by means other than just an accelerometer. For example, usage monitor 118A may be configured to detect movement by detecting changes in location using an asset locating system, such as system 100, or by using GPS or some other type of positioning system. Usage monitor 118A may also be configured to detect shaking, tilting, orientation, and other types of movement that may be indicative of usage.

In another example implementation, asset tag 101 may not perform any sort of comparison, but instead, may transmit an indication of a measured amount of movement to receiver 103, such that either receiver 103 or server 105 performs the comparison. A first movement level may be indicative of the electronic asset not being used while a second movement level is indicative of the electronic asset being used. These different movement levels may either be pre-determined based on asset type or may be empirically determined by monitoring the electronic asset over a period of time.

For some electronic assets where on/off state may not necessarily be a good indicator of the usage of the electronic usage monitor 118A may monitor usage of the electronic asset by tracking current drawn, or power consumed, by the electronic asset. In such an implementation, usage monitor 118A may include an electric current or power monitor. Processor 110 may implement comparison logic that compares a measured current or power value with a threshold current or power value. If the measured current or power exceeds, or in some applications falls below, the threshold current or power value, processor 110 may determine that the asset is active. Additionally or alternatively, if the movement falls below or exceeds the threshold current or power value, processor 110 may determine that the asset is idle or not being used.

FIG. 1C shows an example of receiver 103. Receiver 103 includes one or more processors (processor 120), one or more memories (memory 122), a transmission and receiving (TX/RX) unit 124, also referred to as a transmitter, and a power supply 126. The components of receiver 103 may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof.

Processors 120 may implement functionality and/or execute instructions within receiver 103. Processor 120 is generally intended to represent all processing capabilities of receiver 103. It is contemplated that in some implementations, the processing capabilities of receiver 103 may actually be distributed across multiple processing elements. Processors 120 on receiver 103 may receive and execute instructions stored by memory 122 that control the functionality of TX/RX unit 124 and other units within receiver 103. These instructions executed by processors 120 may cause receiver 103 to store information within or retrieve information from memory 112 during program execution.

Memory 122 within receiver 103 may store information for processing during operation of receiver 103. Memory 122 may include temporary memory that is not for long-term storage. Such temporary memory be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art. Memory 122 may also include one or more computer-readable storage media. Such computer-readable storage media may be configured to store larger amounts of information than volatile memory and may further be configured for long-term storage of information as non-volatile memory space and retain information after power on/off cycles. Examples of non-volatile memories include magnetic hard discs, flash memories, or forms of electrically programmable memories (EPROM) or electrically erasable and programmable (EEPROM) memories. Memory 122 may also store program instructions for execution by processor 120 and/or data associated received from any of asset tags 101A-101C. Memory 122 in receiver 103 is generally intended to represent all the memory and/or data storage devices that may be contained in receiver 103, including, for example, caches, RAM, and storage media.

TX/RX unit 124 may include various mixers, filters, amplifiers, modems and other components designed for signal modulation, as well as one or more antennas and other components designed for transmitting and receiving data. TX/RX unit 124 is generally intended to represent all the communication components and functionality of receiver 103. Receiver 103 may be configured to transmit and receive data using multiple communications protocols. As one example, TX/RX unit 124 may receive information from any of asset tags 101A-101C using Bluetooth and transmit information to server 105 using WiFi and/or a wired LAN connection.

Power supply 126 generally represents any power source or combination of power sources that may be used to power receiver 103. It is contemplated that receiver 103 may be larger than asset tags 101A-101C but still generally small, such as the size of a smoke detector, for example. Accordingly, it is contemplated that power supply 126 may also be relatively small for receiver 103. For example, it is contemplated that some implementations of receiver 103 may operate using one or more AA, AA, C, D, or 9V batteries. In some implementations, receiver 103 may include multiple power sources, such as wall power and battery power.

FIG. 1D shows another example of asset tag 101, which is being affixed to electronic asset 130. Asset tag 101 includes switch 119. Although not explicitly shown in the example of FIG. 1D, asset tag 101 of FIG. 1D may also include the same components shown in the example of FIG. 1B. When asset tag 119 is affixed to electronic asset 130, switch 119 may be depressed which activates asset tag 101, causing asset tag 101 to detect usage of electronic asset 130 and transmit an indication of that usage in the manners described in this disclosure. When asset tag 101 is not affixed to electronic asset 130, switch 119 is not depressed and asset tag 101 may not monitor usage of electronic asset 130. When switch 119 is not depressed, asset tag 101 may transmit to a receiver, such as receiver 103, an indication that asset tag 101 is not affixed to an electronic asset. By receiving an indication that asset tag 101 has been removed, a system administrator may be able to prevent users of electronic asset 130 from tampering with asset tag 101. It should be understood that switch 119 represents just one of the many ways tamper prevention functionality may be introduced into asset tag 101.

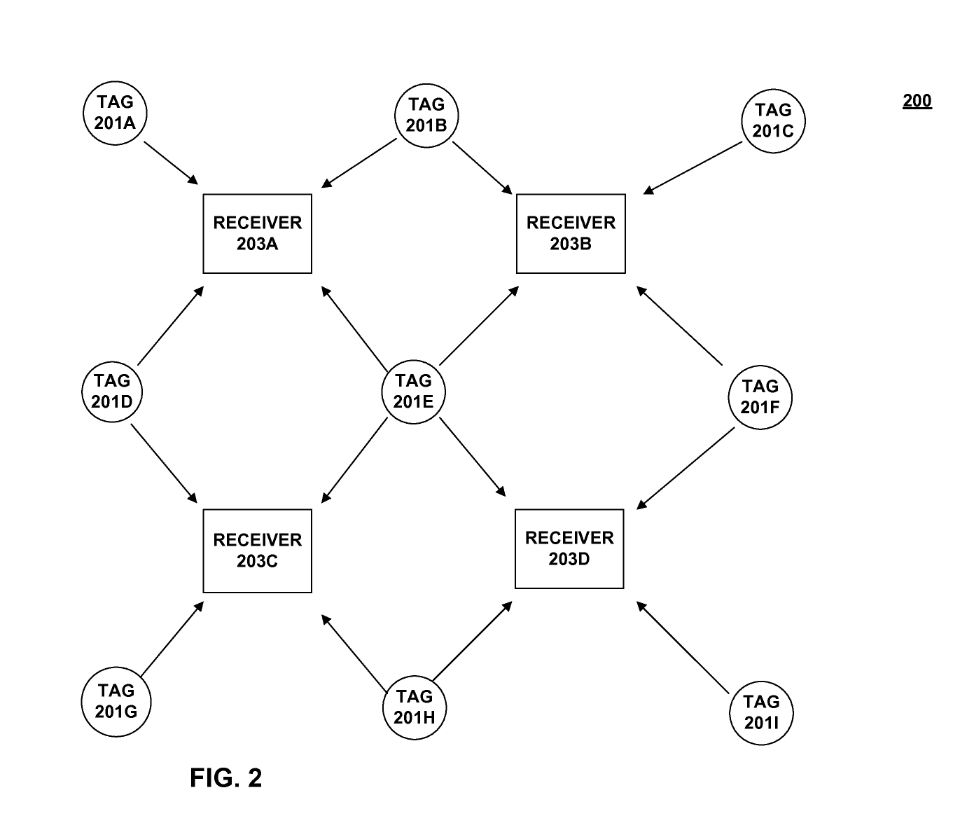

FIG. 2 shows an example of asset tracking system 200. Asset tracking system 200 includes tags 201A-2011 and receivers 203A-203D at different locations within a space or region. Asset tags 201A-2011 may be configured to detect usage and location in accordance with the techniques of this disclosure. Asset tags 201A-2011 may, for example, be configured to perform the techniques described above with respect to asset tags 101 and 101A-101C of FIGS. 1A and 1B. Asset tracking system 200 generally operates in the same manner as asset tracking system 100 of FIG. 1, but FIG. 2 shows more asset tags and receivers. The arrows in FIG. 2 generally correspond to messages being transmitted by asset tags 201A-2011 and detected by receivers 203A-203D. As can be seen in the example of FIG. 2, the messages of some asset tags (e.g. asset tag 201E) are detected by as many as four receivers, while the messages of some asset tags (e.g. asset tags 201A) are detected by only one receiver. Although not shown in FIG. 2, receivers 203A-203D may transmit, to a central server, for example, information identifying the IDs of asset tags for which it has detected messages. Thus, based on which receivers detect the asset tag's message, the central receiver can determine an approximate estimate of the asset tag's location. Asset tags 201A-2011 may also transmit usage information to receivers 203A-203D, and receivers 203A-203D may transmit that usage information to a server or database.

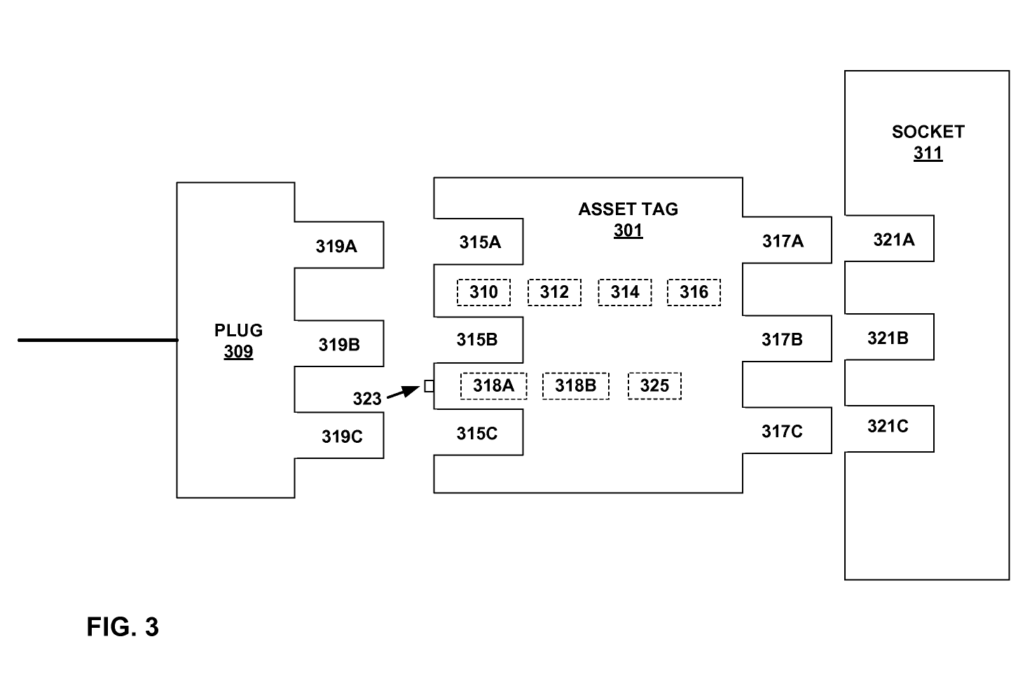

FIG. 3 shows an example of a plug-receptacle device (“asset tag 301”). Asset tag 301 of FIG. 3 shows one example form factor for asset tag 101 of FIG. 1B. Asset tag 30l electrically couples to plug 309, which may, for example, correspond to the power cord of an electronic asset to be tracked. Asset tag 301 electrically couples to socket 311, which may be a line power or other primary power socket for any type of power source, such as a wall outlet, rechargeable battery, non-rechargeable battery, generator, or any other type of power supply. When plug 309 is inserted into asset tag 301 and asset tag 301 is inserted into socket 311, power flows from socket 311 to the electronic asset of plug 309 through asset tag 301, such that the electronic asset of plug 309 operates in the same manner as if plug 309 were plugged directly into socket 311 without asset tag 301.

Asset tag 301 includes three terminals 315A-315C and three pins 317A-317C. Terminals 315A-315C of asset tag 301 comprise a socket portion of asset tag 301, and pins 317A-317C comprise a plug portion of asset tag 301. Plug 309 includes three pins 319A-319C, and socket 311 includes three terminals 321A-321C. As one example, if plug 309 is configured to receive alternating current (AC), pins 319A, 319B, and 319C may correspond to a line (i.e. hot) pin, a grounding pin, and a neutral pin, respectively. Similarly, assuming socket 311 is an AC wall outlet, terminals 321A, 321B, and 321C may correspond to a line terminal, a grounding terminal, and a neutral terminal, respectively. Pin 319A, 319B, and 319C insert into terminals 315A, 315B, and 315C. Pins 317A, 317B, and 317C of asset tag 310 insert into terminals 321A, 321B, and 321C of socket 311. When plug 309 is inserted into asset tag 301, and asset tag 301 is inserted into socket 311, pin 319A is electrically coupled to terminal 321A, pin 319B is electrically coupled to terminal 321B, and pin 319C is electrically coupled to terminal 321C. The three-pin example of FIG. 3 is merely one possible configuration, and it is contemplated that more pins or fewer pins may be used. Moreover, it is contemplated that the example of FIG. 3 may be adapted to be compatible with any of the various domestic and international plug and socket standards, as well as any proprietary standards.

Asset tag 301 also includes one or more processors (processor 310), one or more memories (memory 312), a transmission and receiving (TX/RX) unit 314, also referred to as a transmitter, a power supply 316, and one or more usage monitors. Although FIG. 3 shows two usage monitors (318A and 318B), it is contemplated that asset tag 301 may include more or fewer usage monitors. The components of asset tag 301 may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof.

Asset tag 301, when attached to an electronic device, may be configured to increment a counter when pins 317A-317C are not plugged into a power source, which is indicative of the asset not being utilized. Asset tag 301 may also be configured to measure a current draw or power draw and increment the counter when the current draw or power draw is below a threshold, as a low current draw or low power draw may also be indicative of an asset not being utilized. When the counter exceeds a threshold, asset tag 301 may report an idle period, for example, to a receiver or server. Asset tag 301 may also be configured to monitor if the power cord of the asset is plugged into asset tag 301, and if it is, not the plug-receptacle device may increment the counter.

Processor 110 may implement functionality and/or execute instructions within asset tag 301. Processor 310 is generally intended to represent all processing capabilities of asset tag 301. It is contemplated that in some implementations, the processing capabilities of asset tag 301 may actually be distributed across multiple processing elements. Processors 310 on asset tag 301 may receive and execute instructions stored by memory 312. By executing the instructions, processors 310 may control the functionality of usage monitors 318A-318B and TX/RX unit 314. These instructions executed by processors 310 may cause asset tag 301 to store information, within memory 312 during program execution.

Memory 312 within asset tag 301 may store information for processing during operation of asset tag 301. Memory 312 may include temporary memory that is not for long-term storage. Such temporary memory be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art. Memory 312 may also include one or more computer-readable storage media. Such computer-readable storage media may be configured to store larger amounts of information than volatile memory and may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Memory 312 may also store program instructions for execution by processor 310 and/or data associated with usage monitors 318A and 318B. Memory 312 in asset tag 301 is generally intended to represent all the memory that may be contained in asset tag 301, including, for example, caches, RAM, and storage media.

TX/RX unit 314 may include various mixers, filters, amplifiers, modems and other components designed for signal modulation, as well as one or more antennas and other components designed for transmitting and receiving data. In some implementations, asset tag 301 may include a transmission (TX) unit instead of a TX/RX unit, meaning that asset tag 301 can transmit information but not receive information.

In some implementations, asset tag 301 may be configured to continuously monitor for usage but only periodically transmit usage information to receiver 303. For example, asset tag may only transmit usage information once per day or transmit usage information only when a specific type of usage event is detected. An example of a specific usage event may include an idle period that lasts longer than a threshold period of time. For location tracking purposes asset tag 301 may periodically transmit its unique asset tag ID for detection by one or more receivers.

Power supply 316 generally represents any power source or combination of power sources that may be used to power asset tag 301. In some implementations of asset tag 310, it is contemplated that power supply 316 will include both battery power and another power supply, such as power derived from socket 311. Power supply 316 may also include a battery. When asset tag 301 is coupled to socket 311, asset tag 301 may be powered by socket 311, and when asset tag 301 is not coupled to socket 311, asset tag 301 may be powered by battery. In some implementations, power supply 316 may include a rechargeable battery that is capable of being charged by power received from socket 311. In order to utilize power received from socket 311, power supply 316 may be accompanied by AC-to-DC conversion circuitry, voltage regulation circuitry, and other such circuitry.

Asset tag 301 also includes plug detection component 323 and socket detection circuitry 325. Plug detection component 323 is configured to detect if plug 309 is inserted into asset tag 301. Plug detection component 323 may, for example, be configured to detect pressure applied by plug 309 when plug 309 is inserted into asset tag 301. Plug detection component 323 is just one of many ways in which to implement plug detection functionality into asset tag 301. In other examples, circuitry within asset tag 301 may be configured to detect an electrical coupling between pin 319A and terminal 315A or pin 319C and terminal 315C. Various mechanical means may also potentially be used to detect if plug 309 is inserted into asset tag 301. In some implementations, asset tag 301 may be configured to mechanically lock around all or a portion of a plug 309. Asset tag 301 may include circuitry for detecting if that lock is broken. Socket detection circuitry 325 may, for example, be configured to sense a current or voltage through any of terminals 317A-317C from terminals 321A-321C.

Usage monitors 318A-318B may be configured to detect usage of the electronic asset to which asset tag 301 is affixed. In the example of FIG. 3, usage monitors 318A may be a combination of hardware components and software components configured to detect the usage. Usage monitor 318A may monitor usage of the electronic asset by tracking current drawn or power drawn, from socket 311, by the electronic asset. Usage monitor 318A may, for example, track current or power drawn from socket 311 by the electronic asset using a current meter or power meter. By tracking the current or power drawn, asset tag 301 may determine when the electronic asset is turned on and when it is turned off. Asset tag 301 may additionally track variations in current or power draw, such that it can distinguish between when an electronic asset is powered on and not being used and when the electronic asset is powered on and being used. Asset tag 301 may be programmed with comparison logic that can compare a measured current or power value with a threshold current or power value. If the measured current or power exceeds, or in some applications falls below, the threshold current or power value, asset tag 301 may determine that the asset is active. Additionally or alternatively, if the measured current or power falls below, or in some application exceeds, the threshold current or power value, then asset tag 301 may determine that asset is inactive or idle.

Usage monitor 318B of asset tag 301 may comprise any other asset tracking functionality described in this disclosure. Thus, asset tag 301 may be configured more than one type of usage monitoring. Additionally, asset tag 301 may also implement location functionality as described in this disclosure.

The example of FIG. 3 shows one particular implementation of asset tag 301; however, other plug-receptacle form factors are also contemplated. For example, asset tag 301 may be configured for use with two-pin plugs and two-terminal sockets and may be configured to be compatible with the various international standards for plug and socket configurations. Asset tag 301 may also be configured for use with DC power supplies that includes USB connections, 30-pin connections, Lightning connections, ANSI/SAE J563 compliant plugs and sockets, common External Power Supply (EPS) plugs and sockets, and virtually any other type of plug and socket configuration.

According to the techniques of this disclosure, an asset tag, such as one of asset tags 101A-C of FIG. 1A, asset tag 101 of FIG. 1B, asset tags 201A-2011 of FIG. 2, or asset tag 301 of FIG. 3, may be configured to detect both power on states and temperatures in order to determine that an asset associated with the asset tag has been idle for a period of time that is greater than a threshold period of time. The asset tag may monitor the power state of an asset, and in response to the asset not being powered on, the asset tag increments a counter. Being in a powered off state is an indicator that an asset is not being utilized. While monitoring the power state of the asset, the asset tag may also monitor a temperature, and if the temperature is below a threshold value, the asset tag may likewise increment the counter, for example, if the temperature stays below the threshold for a specified period of time. A temperature below a threshold value may indicate an electronic asset is not being used, even if a device is in a powered on state, the asset may still not be being utilized. Once the counter exceeds a threshold period, the asset tag may report, to a receiver or server, for example, that the asset being monitored is idle.

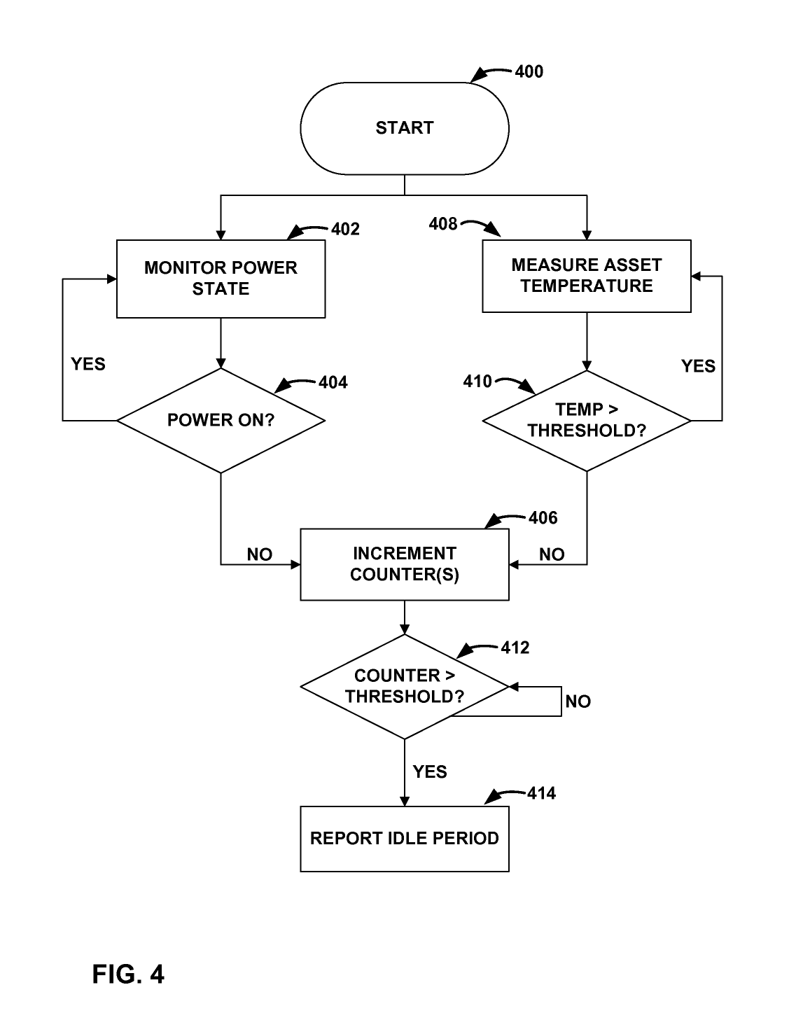

FIG. 4 is a flowchart showing an example idle period determination process according to the techniques of this disclosure. The techniques of FIG. 4 may, for example, be performed solely by an asset tag to determine that an asset associated with the asset tag has been idle for a period of time that is greater than a threshold period of time. Alternatively, the techniques of FIG. 4 may be performed by a combination of an asset tag and a receiver, such as one of receiver 103 in FIGS. 1A and 1C or receivers 203A-203D in FIG. 2. The techniques of FIG. 4 will be described with reference to a generic asset tag and generic receiver. The generic asset tag may, for example, be an asset tag such as one of asset tags 101A-101C of FIG. 1, asset tag 101 of FIG. 1B, one of asset tags 201A-2011 shown in FIG. 2, or asset tag 301 shown in FIG. 3.

The process of FIG. 4 may, for example, begin when an asset tag is installed or activated (400). In some examples, the asset tag may be an after-market device that is attached to an electronic asset, while in other examples, the asset tag may be integrated into the electronic asset. The asset tag may, for example, be configured to monitor a power state of the electronic asset (402) in a manner described above. If the electronic asset is powered on (404, yes), then the asset tag continues to monitor the power state of the electronic asset (402). If the electronic asset is not powered on (404, no), then the asset tag may increment a counter (406). The counter may, for example, record how many times an asset is turned on or off over a number of periodic monitoring samples within a certain window of time or may record the amount of time within a certain window of time that an asset spends in an off state.

In addition to or alternatively to monitoring a power state of an electronic asset, according to the techniques of this disclosure, the asset tag may also monitor a temperature of the asset (408). A change in temperature for the asset may, for example, be an indicator of use. Therefore, monitoring the temperature can indicate when the asset is being used and when it is not being used. The asset tag may, for example, be positioned in or on the electronic asset at a location where it can detect temperature variations that are indicative of use.

In one example, if the asset tag detects a temperature that is greater than a threshold temperature (410, yes), then the asset tag continues monitoring the temperature (408). If the asset tag detects a temperature that is below the threshold (410, no), then the asset tag increments the counter (406). The counter may, for example, record how many times an asset moves beyond the threshold temperature over a number of monitoring samples within a certain window of time or may record the amount of time within a window of time that an asset spends at a temperature below (or potentially above) the threshold temperature. At step 406, an asset tag may maintain separate counters for how many times the electronic asset is powered off and how many times it is below the temperature threshold. Alternatively, the asset tag may maintain one counter that records both how many times the asset is in an off state and how many times the asset is below the temperature threshold. In some implementations, the asset tag may only monitor temperature when the electronic asset is powered on. If the electronic asset is powered off, then the asset tag may only monitor the power state of the electronic asset.

The counter may be maintained by either the asset tag itself, the receiver, or at a server/database. If the counter is maintained by the asset tag, then the asset tag may periodically send the counter value to the receiver. If the counter is maintained by the receiver, then the asset tag may transmit to the receiver information enabling the receiver to maintain the counter.

Regardless of where the counter is maintained, if the counter exceeds a threshold (412, yes), then the system (i.e. any of the asset tag, receiver, or backend server) may report an idle period (414). The system may report the idle period, for example, by sending a notification to a designated individual that the electronic asset is idle, sending an indication, from a receiver to a server, that the electronic asset is idle, or by performing any other type of action in response to the idle period. If the counter does not exceed the threshold (412, no), the system continues maintaining the counter until it does exceed the threshold.

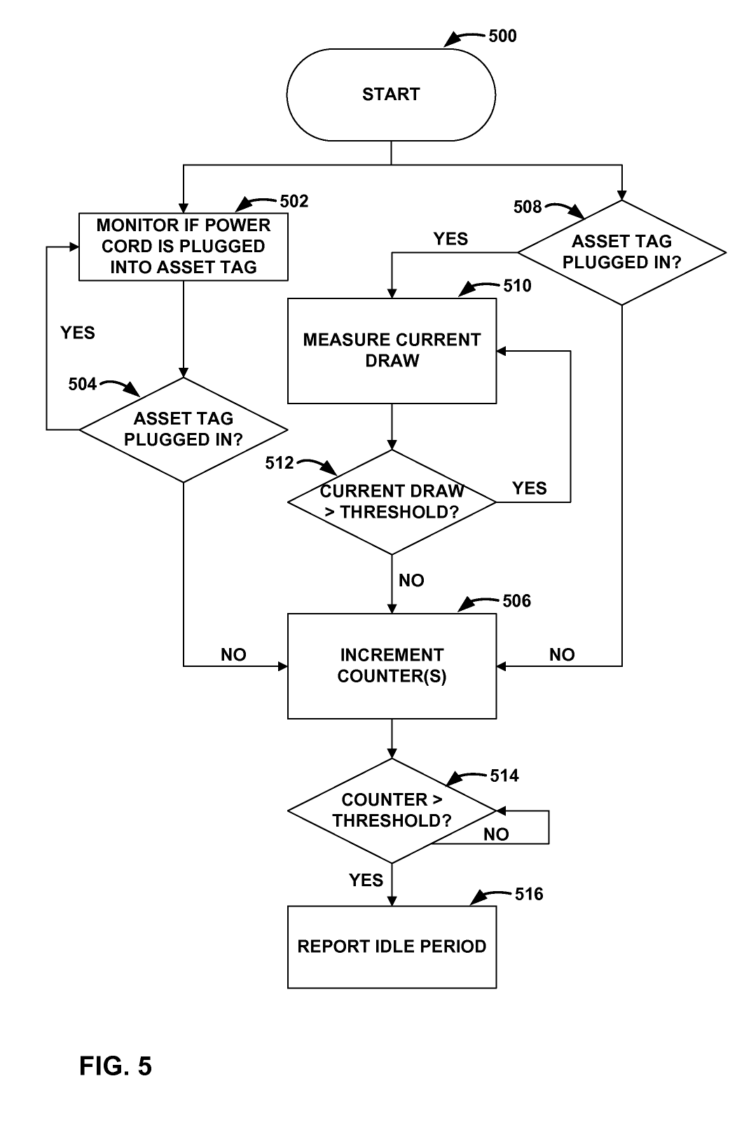

FIG. 5 is a flowchart showing an example idle period determination process according to the techniques of this disclosure. The techniques of FIG. 5 may, for example, be performed solely by an asset tag, such as asset tag 301 of FIG. 3, to determine that an electronic asset associated with the asset tag has been idle for a period of time that is greater than a threshold period of time. Alternatively, the techniques of FIG. 5 may be performed by a combination of an asset tag and a receiver. The techniques of FIG. 5 will be described with reference to a generic asset tag and generic receiver. The asset tag may, for example, be an asset tag such as one of asset tags 101A-101C shown in FIG. 1, one of asset tags 201A-2011 shown in FIG. 2, or asset tag 301 shown in FIG. 3.

The process of FIG. 5 may, for example, begin when an asset tag is installed or activated (500). An asset tag performing the techniques of FIG. 5 may, for example, be an after-market device that is attached to a power cord of an electronic asset in the manner described above with respect to FIG. 3. The asset tag may be activated by a system administrator (“start” 500). Activation may, for example, include installing the asset tag and/or putting the asset tag into a monitoring mode. The asset tag may, for example, be configured to monitor if the power cord of the electronic asset is plugged into the asset tag (502). If the power cord of the electronic asset is plugged into the asset tag (504, yes), then the asset tag continues monitoring if the power cord of the electronic asset is plugged into the asset tag (502). If the power cord of the electronic asset is not plugged into the asset tag (504, no), then the asset tag may increment a counter (506). The asset tag may, for example, implement the counter every time the electronic asset goes a defined period of time without being used.

In addition to monitoring if the power cord of the asset is plugged into the asset tag, the asset tag may also determine if the asset tag is plugged into a power source (508). The power source may, for example, be a wall outlet or any other such power source. If the asset tag is not plugged into a power source (508, no), then the asset tag may increment the counter. If the asset tag is plugged into the power source (508, yes), then the asset tag may measure a current draw of the asset (510). If the current draw is greater than a threshold current value (512, yes), then the asset tag may continue monitoring the current draw (510). If the current draw is less than the threshold (512, no), then the asset tag may increment the counter (506).

The counter may, for example, record how many times a current draw falls below the threshold over a period of monitoring samples within a certain window of time or may record the amount of time within a window of time that the current draw falls below the threshold temperature. At step 506, an asset tag may maintain separate counters for how many times the asset is not plugged into the asset tag, how many times the asset tag is not plugged into the power source, or how many times the asset is below the threshold temperature. Alternatively, the asset tag may maintain one counter that records all three. In some implementations, the asset tag may only monitor current draw when the electronic asset is plugged into the asset tag and the asset tag is plugged into the wall.

The counter may be maintained by either the asset tag itself, the receiver, or at a server/database. If the counter is maintained by the asset tag, then the asset tag may periodically send the counter value to the receiver. If the counter is maintained by the receiver, then the asset tag may transmit to the receiver information enabling the receiver to maintain the counter.

Regardless of where the counter is maintained, if the counter exceeds a threshold (514, yes), then the system (i.e. any of the asset tag, receiver, or backend server) may report an idle period (516). The system may report the idle period, for example, by sending a notification to a designated individual that the electronic asset is idle, sending an indication, from a receiver to a server, that the electronic asset is idle, or by performing any other type of action in response to the idle period. If the counter does not exceed the threshold (514, no), the system continues maintaining the counter until it does exceed the threshold. Although FIG. 5 has generally been described with respect to measuring a current, it should be understood that the techniques of FIG. 5 may also be implemented by measuring a power instead of a current.

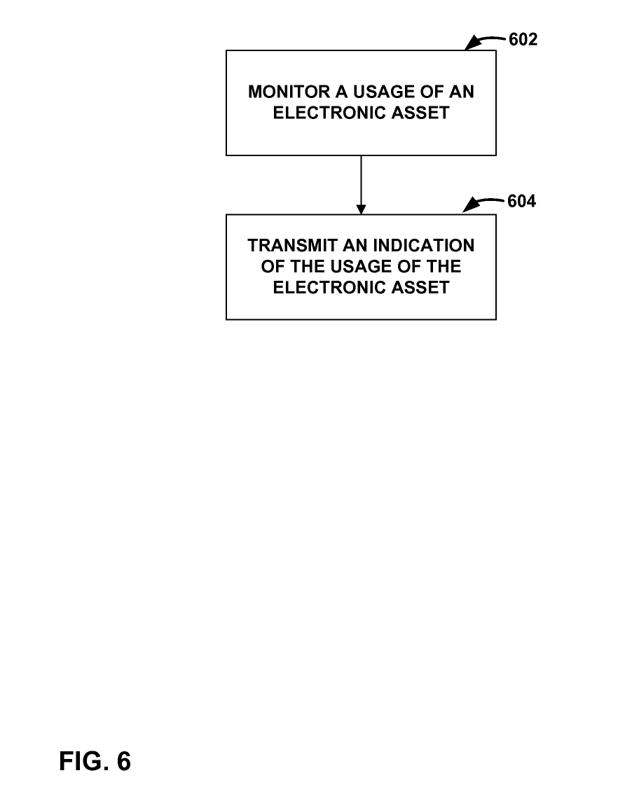

FIG. 6 shows an example process for monitoring usage of an electronic asset. The techniques of FIG. 6 may, for example, be performed solely by an asset tag, such as asset tag 101 of FIGS. 1A, 1B, and 1D or asset tag 301 of FIG. 3. The techniques of FIG. 6 will be described with reference to a generic asset tag. The asset tag monitors a usage of an electronic asset (602). The asset tag may transmit an indication of the usage of the electronic asset (604).

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

1. A method for determining utilization of electronic assets, the method comprising:
monitoring a usage of an electronic asset; and
transmitting an indication of the usage of the electronic asset.

2. The method of claim 1, wherein monitoring the usage comprises detecting a temperature of the electronic asset.

3. The method of claim 1, wherein monitoring the usage comprises detecting an acceleration of the electronic asset.

4. The method of claim 1, wherein monitoring the usage comprises monitoring a current draw of the electronic asset.

5. The method of claim 1, wherein monitoring the usage comprises monitoring a power draw of the electronic asset.

6. The method of claim 1, wherein monitoring the usage comprises monitoring a power state of the electronic asset.

7. The method of claim 1, wherein the indication of the usage comprises an idle time for the electronic asset.

8. The method of claim 1, wherein the indication of the usage comprises an active time for the electronic asset.

9. The method of claim 1, further comprising determining a location of the asset.

10. An asset tag for monitoring usage of an electronic asset, the asset tag comprising:
a usage monitor configured to monitor usage of the electronic asset; and
a transmitter configured to transmit an indication of the usage of the electronic asset.

11. The asset tag of claim 10, further comprising:
a socket configured to receive a first plug, wherein the first plug comprises a plug of the electronic asset;
a second plug electrically coupled to the socket, wherein the second plug is configured to transmit current to the socket;
a power source configured to power the usage detector.

12. The asset tag of claim 11, wherein the power source comprises a battery.

13. The asset tag of claim 11, wherein the usage monitor is configured to detect a voltage at the second plug.

14. The asset tag of claim 11, wherein the usage monitor is configured to measure a current drawn at the second plug.

15. The asset tag of claim 11, further comprising:
circuitry for determining if the first plug is electrically coupled to the socket.

16. The asset tag of claim 11, further comprising:
circuitry for determining if the second plug is electrically coupled to a second power source.

17. The asset tag of claim 10, wherein the usage monitor is configured to monitor an acceleration of the appliance.

18. The asset tag of claim 10, wherein the indication of the usage comprises an idle time.

19. The asset tag of claim 10, wherein the indication of the usage comprises an active time.

20. An apparatus for determining utilization of electronic assets, the apparatus comprising:
means for monitoring a usage of an electronic asset; and
means for transmitting an indication of the usage of the electronic asset.

21. The apparatus of claim 20, wherein the means for monitoring the usage comprises detecting a temperature of the electronic asset.

22. The apparatus of claim 20, wherein monitoring the usage comprises detecting an acceleration of the electronic asset.

23. The apparatus of claim 20, wherein the means for monitoring the usage comprises monitoring a current draw of the electronic asset.

24. The apparatus of claim 20, wherein the means for monitoring the usage comprises monitoring a power draw of the electronic asset.

25. The apparatus of claim 20, wherein the means for monitoring the usage comprises monitoring a power state of the electronic asset.

26. The apparatus of claim 20, wherein the indication of the usage comprises an idle time for the electronic asset.

27. The apparatus of claim 20, wherein the indication of the usage comprises an active time for the electronic asset.

28. The apparatus of claim 20, further comprising:
means for determining a location of the asset.

29. A computer-readable medium storing instructions that when executed cause one or more processors to:
monitor a usage of an electronic asset; and
transmit an indication of the usage of the electronic asset.

30. The computer-readable storage medium of claim 29 storing further instructions that when executed cause the one or more processors to monitor the usage of the electronic asset by doing one or more of:
detecting a temperature of the electronic asset;
detecting an acceleration of the electronic asset;
monitoring a current draw of the electronic asset;
monitoring a power draw of the electronic asset; and
monitoring a power state of the electronic asset.
